(19) United States
(12) Patent Application Publication
(10) Pub. No.: US 2002/0119294 A1
(43) Pub. Date: Aug. 29, 2002

(54) Light-emitting, light-rechargeable labels for containers

(76) Inventors: Jason Monkarsh, West Hollywood, CA (US); Steeve Bohbot, Beverly Hills, CA (US)

Correspondence Address: PHILIP K. YU, 20955 Pathfinder Road, Suite 160, Diamond Bar, CA, 91765, US

(21) Appl. No.: 09/795,223

(22) Filed: Feb. 28, 2001

(51) Int. Cl. B32B 5/00

(52) U.S. Cl. 428/195

(57) ABSTRACT

A light-emitting, light-rechargeable label for containers and the method of making the label is disclosed. The substrate for the label is made of Polyvinyl Chloride, or PVC. The substrate is printed with a phosphorescent ink to create the desired glow in the dark, light-emitting label. The phosphorescent ink is Strontium based, comes in a powder form and is mixed with a clear UV curable flexographic ink solvent. The PVC sheets are then run through a flexographic printing press to be printed with at least one layer of the phosphorescent ink. The printed sheets are then cut, formed and bonded into label sleeves, which are heat shrunk onto a container or bottle through either a hot air or steam shrink tunnel machine. The finished product is a bottle whose label looks white with a printed image with normal ambient light.

### FIELD OF THE INVENTION

This invention is related to labels for containers and more particularly to a light-emitting and light-rechargeable, or phosphorescent, label for containers and the method of making the label. The related technical areas are: selection or formulation of a high volume, low cost commercial printing process and associated compatible materials set comprising a preferably heat shrinkable label substrate and a phosphorescent printing ink. Furthermore, the subsequently printed image is preferably compatible with the final heat shrink process onto a container or bottle wherein the label is briefly exposed to an elevated temperature of approximately 200 degrees Fahrenheit.

### BACKGROUND OF THE INVENTION

In the art of making labels for a variety of containers, bottles or other products, it is often desirable to have the labels capable of emitting light, or glowing, in the dark by itself to provide some useful function. One example of such need can be found in beverage containers such as bottles or cans for water, soda, juice, energy drinks, and tea which can be seen easier at night by children and adults for amusement and safety reasons.

Another example is in the pharmaceutical and cosmetic industry, where light emitting labels allow the elderly to see their medicine bottles more easily at night. The light emitting label would also make taking their medicine appear to be more fun for the children. Additional use of the light emitting label includes toothpaste, soaps, lip balms, lip sticks, nail polish, shampoos, makeup, and other pharmaceutical and cosmetic items.

Light emitting labels can be applicable to automobile service industry as well. The light emitting label can serve as a packaging material for oil cans, emergency gas containers and other automotive items. Thus, these packaged automotive products would provide more visibility for those working on their automobiles at night.

Finally, the labels can be applicable in the toy industry, where light emitting labels can be used to package a variety of toys for children for more fun. Examples are markers, crayons, pens, bubble bottles, art supplies and other toys.

The art of label-making has also been described in several U.S. Pat. No. 5,172,937 issued to Sachetti, titled Combined Fluorescent and Phosphorescent Structures, disclosed structures with fluorescent and phosphorescent materials to reflect and emit light to provide a sense of identity, security, comfort and amusement. The patent also disclosed a method of making a cover with such materials. The phosphorescent material may be a PolyVinyl Chloride (PVC) plastisol ink, or a water based ink. The phosphorescent material may be applied to a sheet member by spray painting, silk screen painting or a roller coating processes. The combined application of phosphorescent and fluorescent materials to sheet members, such as product labels, paper, books, signs and directly on products, provided light designs that are self-illuminating in a dark environment or reflect light when subjected to a black light.

U.S. Pat. No. 5,605,230 issued to Marino, Jr. et al., titled Sealed Label Having Anti-Counterfeit Construction, disclosed a sealed multi-layer label for a container such as a pharmaceutical container, where the label is adhesively applied to the back side of the container. The printed indicia is provided on the front side of the label such that it is readable by the customer upon removal of an overlying sleeve. The sleeve is in the form of merely a protective film, which is heat shrunk to conform to the container. Printing the indicia onto the surface of the label can be done by a flexographic printing machine using water-based ink. The patent also mentioned that the film is a heat shrinkable PVC material and the adhesive is heat activated.

U.S. Pat. No. 5,698,301 issued to Yonetani, titled Phosphorescent Article, disclosed a phosphorescent article which has a phosphorescent layer and a transparent resin layers sequentially superposed on a reflective layer. The phosphorescent layer has SrAl₂O₄ as a phosphorescent pigment and, while the transparent resin layer is made of a transparent resin containing no UV light absorber. This kind of article can be used in applications such as marks and signs for disaster prevention and safety, as well as accessories. The transparent resin layer may be made using a material such as PVC. To form the phosphorescent layer, the phosphorescent pigment, e.g. SrAl₂O₄, is dispersed in a varnish prepared by dissolving a resin, e.g. PVC, in a solvent thereby preparing an ink and printing or applying this ink on a surface by means such as silk screen printing.

U.S. Pat. No. 2,051,665 issued to John Edward West, titled Luminous Label, disclosed a luminous label for containers, bottles or the like. The letters are raised from the outer face of the body section, which is preferably made from sheet material (e.g. celluloid) having transparence. Within the hollows of such letters, it contained a compound of self-luminous substance or radioactive substance.

U.S. Pat. No. 1,349,396 issued to Ray Alan Van Clief, titled Label, disclosed a label formed by applying luminous paint onto an inner sheet and then applying an outer sheet to the inner sheet so as to cause them to coalesce. The final label thus has the look of one single sheet of celluloid securely enclosing the painted letters.

U.S. Pat. No. 2,341,583 issued to R.L. Tuve, titled Luminescent or Phosphorescent Coating Material, disclosed a luminescent material for use as “glow-in-the-dark” designs and the method of making such material. The material can be made by applying a layer of phosphorous pigments to a transparent plastic tape, e.g. “cellophane” tape, having a coating of adhesive. The adhesive coating serves to retain the layer of phosphorous crystals which may be ground to a suitable size.

Despite the numerous examples of label-making in the art, there are still some disadvantages in the conventional way of making light-emitting labels in terms of high-volume production and quality labels.

### SUMMARY OF THE INVENTION

The present invention is directed to a total solution comprising a low cost, high volume printing and packaging process with an associated compatible materials set to mass produce containers or bottles with light emitting labels.

The first objective of this invention is to combine conventional printing such as flexographic printing and heat shrink technique to create a clean looking product that gives the appearance that the actual container is emitting light in the dark and not the label.

The second objective of this invention is to identify and develop a materials set of heat shrinkable printing substrate and phosphorescent ink compatible with the conventional printing such as flexographic printing and heat shrink process.

The third objective of this invention is to optimize the actual flexographic printing and heat shrink process details such that the resulting light emitting label exhibits superior light emitting intensity with long mechanical life.

### BRIEF DESCRIPTION OF DRAWINGS

FIG. 1A and FIG. 1B illustrate the mixing of a phosphorescent powder with a clear flexographic ink solvent to create a phosphorescent flexographic ink mixture.

FIG. 2A illustrates the multi-station, multi-ink layer printing onto a PVC print substrate with a flexographic printing press using the phosphorescent flexographic ink mixture at one of the ink transfer station. The resulting printed and cut multi-layer image structure is illustrated in FIG. 2B.

FIG. 3A illustrates the flip-over of the printed and cut multi-layer image structure from FIG. 2B. The resulting image structure is illustrated in FIG. 3B.

FIG. 4A illustrates the application of an edge seal adhesive in combination with the rolling of the image structure from FIG. 3B to form a label sleeve. The resulting pre-shrunk label sleeve is illustrated in FIG. 4B.

FIG. 5A illustrates the fitting of the pre-shrunk label sleeve from FIG. 4B over a beverage bottle with an indication of the shrinkage of the label sleeve during a subsequent heat shrink process.

FIG. 5B illustrates the achieved conforming fit of the post-shrunk phosphorescent label cylinder with the bottle after a final heat-shrinking process.

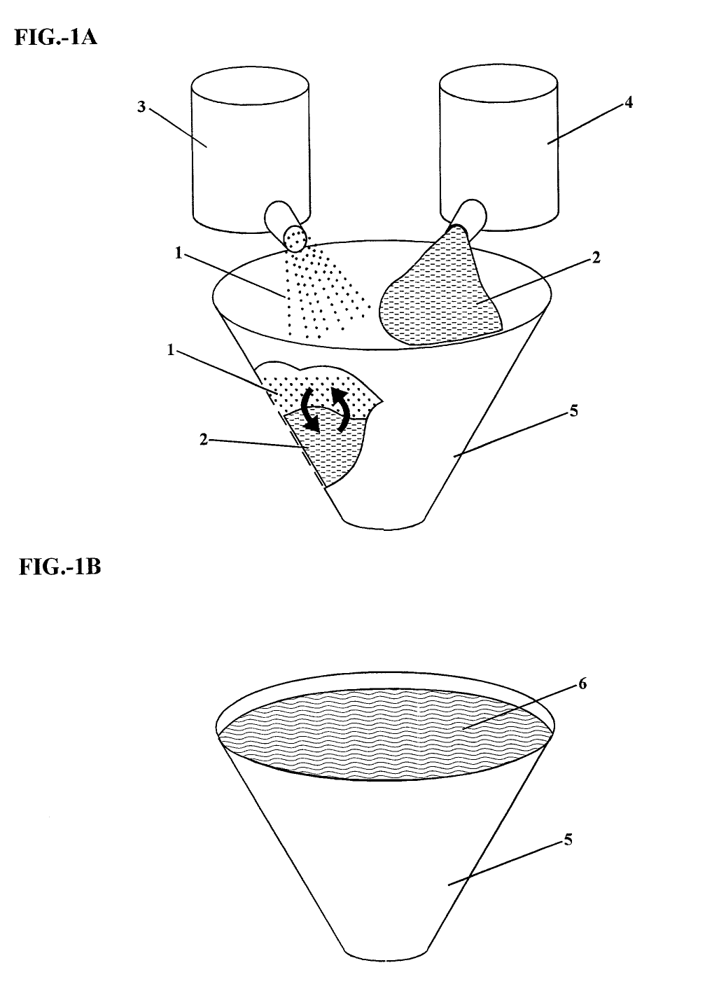

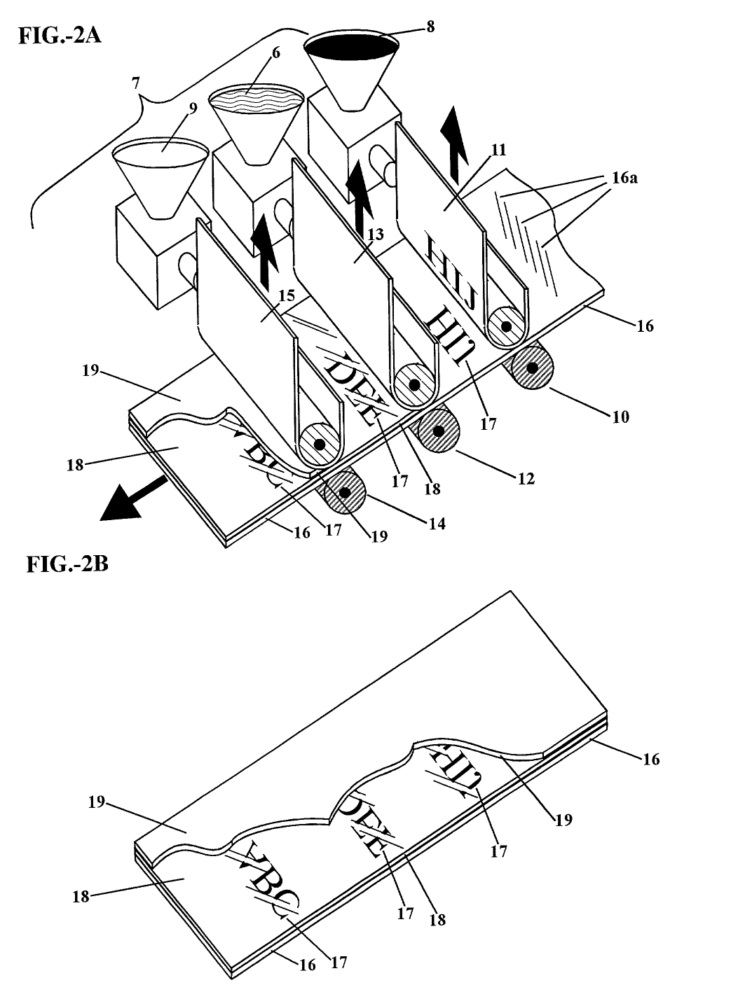

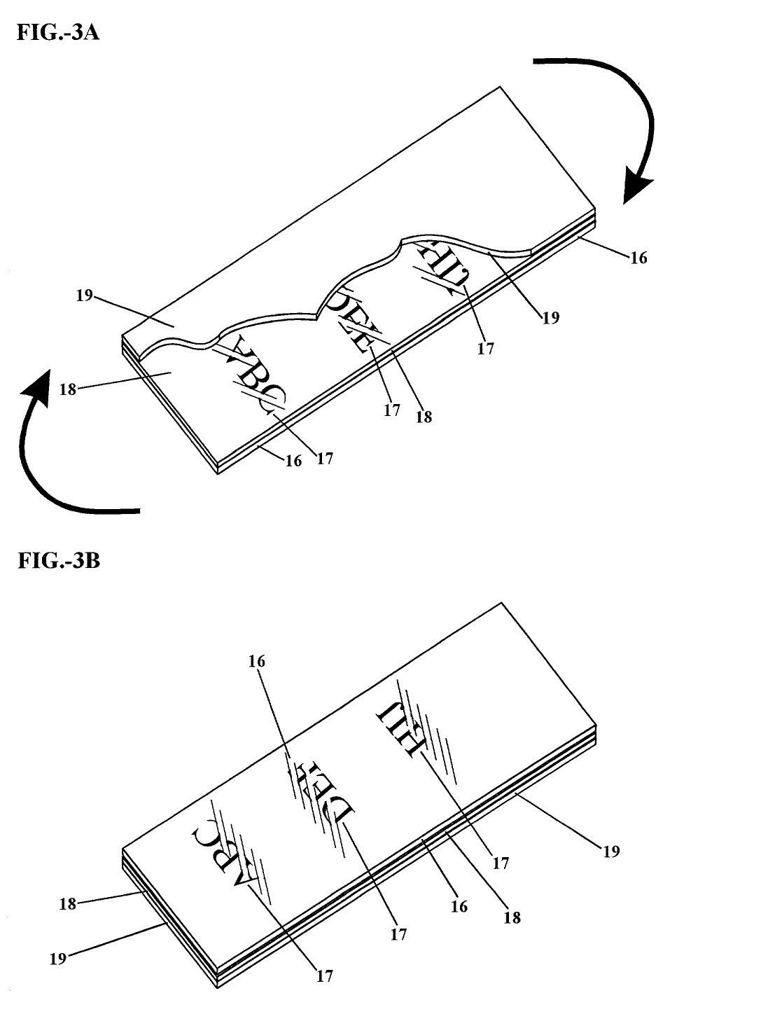

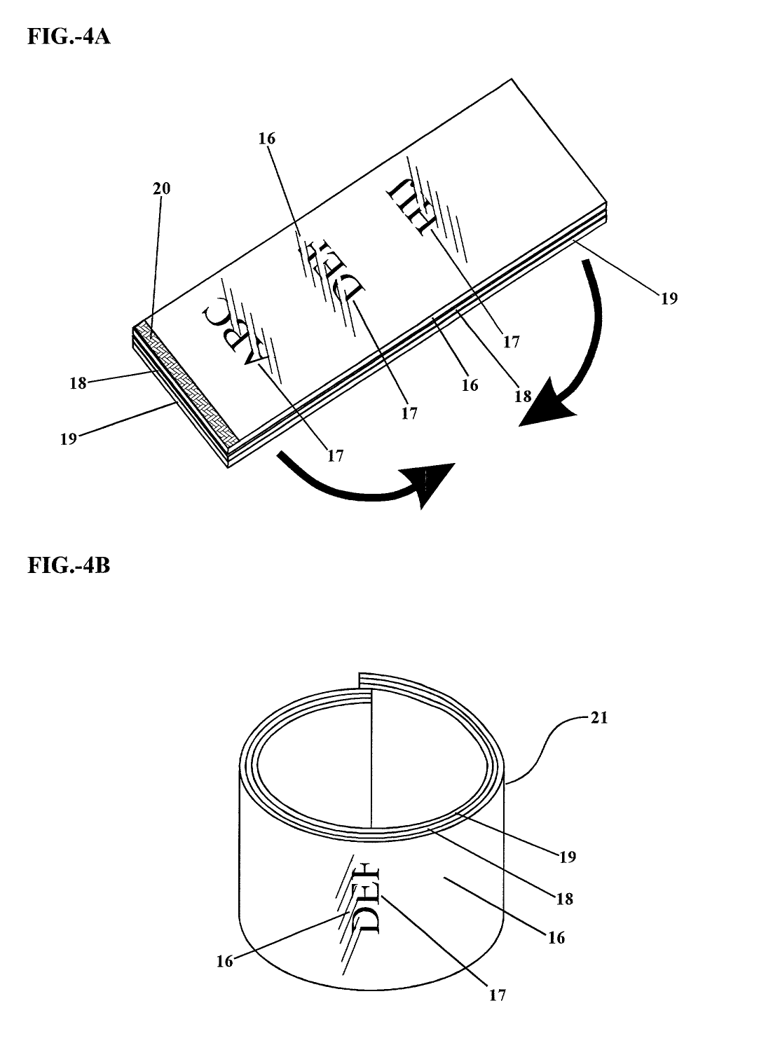

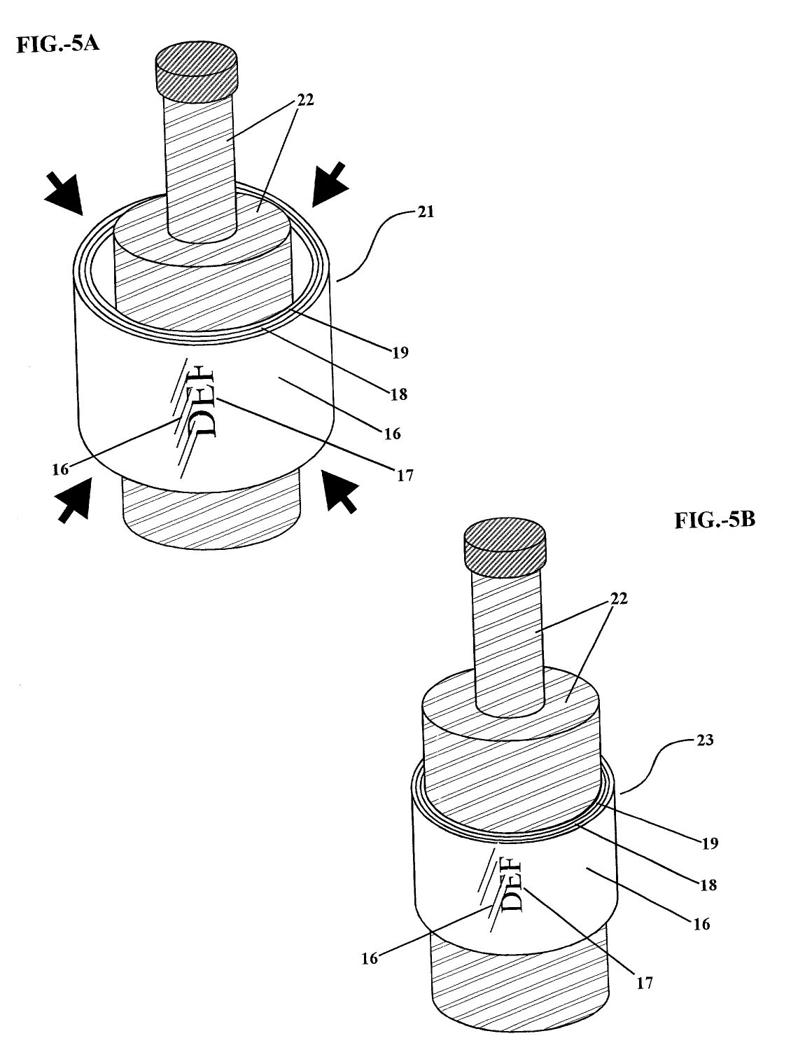

### DETAILED DESCRIPTION OF PREFERRED EMBODIMENTS

FIG.-1A illustrates the mixing of a phosphorescent powder with a clear flexographic ink solvent to create a phosphorescent flexographic ink mixture. A container for phosphorescent powder 3 and a container for clear flexographic ink solvent 4 are disposed above a mixing container 5. The appropriate amount and proportion of phosphorescent powder 1 and clear flexographic ink solvent 2 are metered into the mixing container 5 which has a built in means to thoroughly mix the said two components. The mixing action is indicated with the two rotating arrows. Currently, an amount of about 30% to 40% of the phosphorescent powder is preferably mixed with the ink solvent.

Upon completion of the mixing action, as shown in FIG.-1B, a resulting uniform phosphorescent flexographic ink mixture 6 is contained inside the mixing container 5 ready to be used by the next step. The required phosphorescent powder needs to be formulated into a printing ink which is compatible with the print substrate, the subsequent printing and processing steps and to provide a sufficient level of phosphorescent intensity. To begin with, a thin, transparent and heat shrinkable Polyvinyl Chloride (PVC) film is selected to be the print substrate as it is a commonly available high volume and low cost material. Next, the required phosphorescent powder is preferably a Strontium based phosphorescent powder which is non-hazardous. As can be appreciated by those skilled in the art, other phosphorescent powder may be used, such as Zinc Sulfide, depending on the circumstances. For example, Zinc Sulfide is phosphorescent, but its intensity does not last as long. It may also be toxic.

The formulation of the Strontium-based phosphorescent powder into a printing ink calls for additional considerations by those skilled in the art when practicing the present invention. For example, when the Strontium-based phosphorescent powder is mixed with an Ultra Violet (UV) screen printing ink, the printed ink may tend to be too thick such that it would likely crack off of the PVC print substrate during the following heat shrinking step. Additionally, it could stick to a rotogravure printing press thus making the maintenance of the press rather difficult. It should be appreciated that these are considerations ordinarily encountered by those skilled in the art when deciding on the materials to use for their process.

For another example, with a water-based ink, the Strontium-based phosphorescent powder may not stay in the ink. The ink may be more difficult to print with, and the printed ink may not stick to the PVC print substrate either. Mixing the powder with a non-UV curable solvent may create an ink that will screen print onto the PVC substrate. However, this printed ink still may not stick to the PVC substrate. If a light enough coating is applied during the printing process to make it stick, the ink sometimes could crack and fall off of the PVC again, when heat shrinking the printed label onto a container. Although there are existing phosphorescent inks, they may be too thick to use for a printed label that needs to conform to the shape of the container. That is, the thin PVC print substrate of choice may be more difficult to be coated by the existing phosphorescent inks.

Finally, when the Strontium-based, e.g. Strontium Aluminate, phosphorescent powder is mixed with a clear UV curable flexographic ink solvent, the resulting transparent printing ink is found to be compatible with the flexographic printing press. It is also printable and will stick to the thin PVC print substrate through the heat shrinking process. Notwithstanding this fact, the aforementioned type of ink cracking may still occur if too much ink is used in the flexographic printing process. When only one to two coats of ink is applied to the PVC print substrate, the printed ink will stick to the thin PVC substrate through the entire heat shrink process. Other print substrates may be Polyester and Polyethylene.

With respect to the glow-in-dark ink, it is available under the brand name, Rad-Glow, from Radcure Corporation, 9 Audrey Place, Fairfield, N.J. 07004, Telephone No. 973-808-1002, with a web site at http://www.radcure.com. Also, a company in Japan, Nemoto & Co., LTD., makes a phosphorous powder under the name LUMINOVA™.

Further, it should be appreciated by those skilled in the art that the printing and subsequent heat shrinking can still be done, by other processes such as rotogravure and screen printing, based on their particularly requirements. Although the preferred combination, in terms of ease of process control, is one using the said Strontium-based phosphorescent powder mixed with a clear UV curable flexographic ink solvent, followed by printing on a flexographic printing press, other methods of printing may work just as well. For example, with a rotogravure printing press, a solvent based phosphorescent ink can still be used up to certain, e.g. three, coats using a 120 line screen cylinder.

With the selection of a materials set for the print substrate, the printing ink and an associated printing process, a preferred flexographic printing process is illustrated in FIG.-2A. It is remarked that no attempt has been made here to illustrate any details of the flexographic printing press 7 itself, since such printing presses are well-known to those skilled in the art. As shown in FIG.-2A, going from the right to the left following the left pointing arrow, the PVC print substrate 16 is transported and printed successfully through an image ink transfer station 10 supplied by its associated image ink 8, a phosphorescent flexographic ink mixture transfer station 12 supplied by its associated phosphorescent flexographic ink mixture 6, and finally a white ink transfer station 14 supplied by its associated white ink 9. As explained before and illustrated here with a set of parallel lines 16a, the thin and heat shrinkable PVC print substrate 16 is substantially transparent. Thus, a printed image ink layer 17, located on top of the PVC print substrate 16, is generated from its associated image ink transferring medium 11 at the image ink transfer station 10. Although a single layer of black printed image ink layer 17 is illustrated here for simplicity, it should be understood that, in general, a number of color ink layers of individual image designs can and will be printed atop the PVC print substrate 16 for maximum aesthetic quality. Next, a printed phosphorescent flexographic ink mixture layer 18, located on top of the just printed image ink layer 17, is generated from its associated phosphorescent flexographic ink mixture transferring medium 13 at the phosphorescent flexographic ink mixture transfer station 12. Although a single phosphorescent flexographic ink mixture transfer station 12 is illustrated here for simplicity, it should be understood that, in general, more layers of the printed phosphorescent flexographic ink mixture layer 18 can be applied, within limit and as appropriate, atop the printed image ink layer 17 for higher phosphorescent intensity. As remarked before, within the preferred limit of two coats of the printed phosphorescent flexographic ink mixture layer 18, the printed phosphorescent flexographic ink mixture layer 18 will stick to the PVC print substrate 16 through the entire heat shrink process. In practice, one and a half coats of the printed phosphorescent flexographic ink mixture layer 18 is found to provide a satisfactory balance between the resulting phosphorescent intensity and the reliability through the heat shrink process. As explained before, like the PVC print substrate 16, the printed phosphorescent flexographic ink mixture layer 18 is also substantially transparent and thus indicated in a similar manner with the printed image ink layer 17 showing through.

Finally, a printed white ink layer 19, located on top of the just printed phosphorescent flexographic ink mixture layer 18, is generated from its associated white ink transferring medium 15 at the white ink transfer station 14. As the printed white ink layer 19 is opaque, it is shown to block the visibility of the underlying layers 18, 17 and 16. Separately, upon completion of this printing process, the multi-layer structure is illustrated in FIG.-2B.

FIG.-3A is a repeat of FIG.-2B with the addition of two rotating arrows indicating the simple action of flipping over the just printed multi-layer structure. Afterwards, the same multilayer structure is illustrated in FIG.-3B. Notice, as remarked before, the transparent nature of the PVC print substrate 16 with the underlying printed image ink layer 17 showing through. However, the action of flipping over has mirrored the printed image ink layer 17 such that they are now, as contrasted to FIG.-3A, oriented correctly for reading.

FIG.-4A is a repeat of FIG.-3B with the addition of an edge seal adhesive 20 and two rotating arrows indicating the simple action of rolling the multi-layer structure into a sleeve with the printed white ink layer 19 facing inside and the smooth PVC print substrate 16 on the outside. Equivalently, a sleeve sealing machine well known in the art can be used for this purpose. The resulting bonded, with the said edge seal adhesive 20, pre-shrunk phosphorescent label cylinder 21 is illustrated in FIG.-4B.

FIG.-5A shows the fitting of the pre-shrunk phosphorescent label cylinder 21 over a beverage bottle 22 for a subsequent heat shrink process, wherein the resulting shrinkage of the pre-shrunk phosphorescent label cylinder 21 is indicated by the four pointing arrows. As the machine and its associated process for heat shrink is well known in the art, they are not indicated here. In general, the beverage bottle 22 with the just fitted pre-shrunk phosphorescent label cylinder 21 are run through either a hot air or steam shrink tunnel machine briefly at a temperature of approximately 200 degrees Fahrenheit. The resulting post-shrunk phosphorescent label cylinder 23 is shown tightly fit onto the beverage bottle 22 in FIG.-5B. Due to the phosphorescent property of the post-shrunk phosphorescent label cylinder 23, the finished beverage bottle 22 gives the appearance that the bottle itself glows green in the dark and not the label because of the tight, conforming fit of the post-shrunk phosphorescent label cylinder 23. The average glowing time is between 5 minutes to five hours, depending on how long the post-shrunk phosphorescent label cylinder 23 is photo-charged and how many coats of the printed phosphorescent flexographic ink mixture layer 18 are applied to the post-shrunk phosphorescent label cylinder 23.

Thereafter, the glow-in-the-dark characteristics can be restored quickly under the charging action of any light source to glow green in the dark again. Under normal ambient light, the post-shrunk phosphorescent label cylinder 23 appears white. As remarked before, the PVC print substrate 16 is transparent such that it allows the emitted light from both the printed image ink layer 17 and the printed phosphorescent flexographic ink mixture layer 18 to go through thus becoming visible as a necessity. However, approximately half of the said emitted light goes inwards toward the beverage bottle 22. With the added printed white ink layer 19 being now the inner most layer of the post-shrunk phosphorescent label cylinder 23, the printed white ink layer 19 would reflect these inward directing light beams into outward directing beams, thus effectively doubling the related intensity of both the printed image and the phosphorescent activity.

It should be noted that while a heat-shrinkable PVC film is described as the substrate, other materials can be used to create glow-in-the-dark labels, by printing on paper labels, plastic adhesive labels or pressure sensitive labels, using the mixture of phosphorous powder and UV curable ink solvent as described above. In other words, the novel mixture of phosphorous ink mixture can be applied to various forms of materials to form glow-in-the-dark and rechargeable labels. As an example, a flexographic printing process, or even screen printing process, can be applied to plastic adhesive labels to achieve “glow in the dark” effect by using the above-mentioned ink mixture. For pressure sensitive labels, a screen printing process may be used with a screen size of 110-156 mesh polyester. For a flexographic printing process, a 55-85Q anilox line is preferable for use with the PVC film substrate.

As described, a specific materials set and associated method of flexographic printing and heat shrinking have been illustrated to create a clean looking container with a tightly fit phosphorescent label which gives the appearance that the actual container glows green in the dark and not the label. The invention has been described using exemplary preferred embodiments. However, for those skilled in this field, the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

We claim:

1. A phosphorescent ink for subsequent printing onto a label to yield a glow-in-the-dark label, said ink being made by mixing a phosphorescent powder with a UV curable ink solvent.

2. The ink of claim 1, wherein the phosphorescent powder comprises either one of Strontium-based phosphorescent powder and zinc sulfide powder.

3. The ink of claim 1, wherein the label is made of heat-shrinkable Polyvinyl Chloride (“PVC”) material.

4. The ink of claim 2, wherein the label is one of heat-shrinkable PVC material, plastic adhesive material and pressure sensitive material.

5. A printed multi-layer film label, suitable for being adapted to apply to a container, comprising:
a substrate which is made of a substantially transparent, heat shrinkable material;
at least one layer of printed image ink applied to the substrate;
at least one layer of a printed phosphorescent ink applied to the layer of printed image ink, said phosphorous ink being either one of Strontium- and Zinc Sulfide-based phosphorous powder, and
one top layer of reflective, white ink.

6. The film label of claim 5, wherein the layers of printed phosphorous ink are applied to the substrate through either one of flexographic printing process and rotogravure printing process.

7. The film label of claim 5, wherein the substrate is made of heat-shrinkable polyvinyl chloride material.

8. The film structure as in claim 5, wherein the printed image ink is either one of black and color image ink.

9. A method of making a phosphorescent label for containers, comprising the following steps:
providing a substantially transparent film substrate of a predetermined size;
printing at least one layer of image ink on top of the said film substrate;
printing at least one layer of a phosphorescent ink on top of the said at least one layer of image ink;
printing one top layer of reflective, white ink on top of the said at least one layer of phosphorescent ink, and
fitting the printed multi-layer film to a container.

10. The method of claim 9, wherein the step of fitting comprises:
forming the just printed multi-layer film into a sleeve;
fitting the said sleeve over a container, and
heat shrink the said sleeve onto the said container.

11. The method of claim 9, wherein the steps of printing comprise one of flexographic printing and rotogravure printing.

12. The method of claim 10, wherein the steps of printing comprise one of flexographic printing and rotogravure printing.

13. The method of claim 9, wherein the phosphorous ink comprises Strontium based phosphorous powder and clear ultra violet curable ink.

14. A container product, comprising:
a container, and
a conforming phosphorescent label to the container, wherein the label comprises:
a substrate which is made of a substantially transparent, heat shrinkable Polyvinyl Chloride (“PVC”);
at least one layer of printed image ink applied to the substrate;
at least one layer of a printed phosphorescent ink applied to the layer of printed image ink; and
one top layer of reflective, white ink.

15. The container of claim 14, wherein the at least one layer of phosphorous ink is applied to the substrate using either one of flexographic printing process and rotogravure printing process.

16. The container of claim 14, wherein the phosphorescent ink comprises a mixture of a phosphorescent component and a UV curable ink solvent component, said phosphorescent component being based on one of Strontium and Zinc Sulfide.

17. The container of claim 15, wherein the phosphorescent ink comprises a Strontium-based phosphorescent component and a UV curable ink solvent component.

18. A container product, comprising:
a container having a predetermined exterior shape;
a fitted phosphorescent label conforming to at least a portion of the exterior shape of the container, wherein the label is made by the following steps:
providing a substantially transparent, heat-shrinkable film substrate of a predetermined size;
printing at least one layer of an image ink on top of the said film substrate;
printing at least one layer of a phosphorescent ink on top of the said layer or layers of black or other color image ink;
printing one top layer of reflective, white ink on top of the said layer of phosphorescent ink;
forming the just printed multi-layer film into a heat shrinkable phosphorescent label sleeve;
fitting the said heat shrinkable phosphorescent label sleeve over the container product and heat shrink the said heat shrinkable phosphorescent label sleeve onto the said container product.

19. The container according to claim 18, wherein the steps of printing comprise flexographic printing process.

20. The container according to claim 18, wherein the steps of printing comprise rotogravure printing process.
